(19) United States
(12) Patent Application Publication
(10) Pub. No.: US 2001/0025238 A1
(43) Pub. Date: Sep. 27, 2001

(54) Emulation system and method

(76) Inventors: Toru Kitajima, Hadano (JP); Hiroshi Tomita, Hadano (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/779,859

(22) Filed: Feb. 9, 2001

(30) Foreign Application Priority Data
Feb. 9, 2000 (JP) 2000-032335

(51) Int. Cl. G06F 9/455

(52) U.S. Cl. 703/28

(57) ABSTRACT

A multi-valued logic emulation system reads a specifying value for specifying with which value, logic emulation is performed, and represents the logic value by a plurality of physical signal lines equal to (Log₂ a raised integer of the specifying value). Then, the system performs multi-value supporting synthesis and automatic place/automatic route processing, and maps resulting information to a programmable gate array, thereby making it possible to execute multi-valued logic emulation.

### BACKGROUND OF THE INVENTION

1. Technical Field of the Invention

The present invention relates to a logic emulation system and method which perform multi-valued logic emulation using a programmable gate array, and more particularly, to a logic emulation system and method suitable for use in an analysis on an operational failure in a logic circuit under emulation.

2. Related Technology

As the prior art related to the logic emulation, there are known a method which uses a field programmable gate array (FPGA), and a method which uses a processor dedicated to emulation as disclosed in U.S. Pat. No. 5,923,865 and so on. Either of these prior art methods is performed for a plurality of processors (programmable gate arrays) interconnected to one another and mounted on a substrate.

A programmable gate array is mainly comprised of multiple logic cell blocks and a route bus, and a logic cell block in turn is mainly comprised of a logic configuration unit and a route selection unit. The logic configuration unit is mainly comprised of a lookup table, flip-flops and selectors, and has an output connected to the route bus through the route selection unit. The lookup table is typically organized in a multiple-inputs/one-output structure, and used to implement an arbitrary logic function.

In the prior art as described above, one logic value is represented by one physical signal line (one bit), so that available logic values are limited to only two, i.e., “0” and “1”. Therefore, the prior art has a problem that it is incapable of performing logic emulation of three values or more.

### SUMMARY OF THE INVENTION

The present invention provides a logic emulation system which comprises means for previously specifying with which value, logic emulation is performed, and represents one logic value by a plurality of physical signal lines expressed by a “Log₂ a raised integer of (the specifying value)” to enable multi-valued logic emulation of three or more values.

The present invention provides a logic emulation system based on multi-valued logic for emulating a logic under verification, which comprises a synthesis unit for synthesizing a multi-value supporting logic, a mapping unit for performing automatic place/automatic route processing, and mapping the resulting information to a programmable gate array, and an emulation unit for performing multi-value supporting logic emulation using a multi-valued emulation program created during the mapping.

Also, in the present invention, the logic emulation system performs one logic gate operation using one or a plurality of programmable devices in the programmable gate array in a one-input/one-output configuration, a one-input/multiple-output configuration, a multiple-input/one-output configuration, or a multiple input/multiple output configuration to implement a multi-valued logic operation.

Further, the synthesis unit implements one logic signal line by a plurality of physical signal lines, or reads a specifying value for specifying with which value the synthesis is performed, to perform the synthesis corresponding to the specifying value.

The synthesis unit also performs the synthesis using a specifying value for specifying with which value the synthesis is performed, and information on a logic cell stored in a cell library for multi-value supporting synthesis. Alternatively, the synthesis unit reads a value that specifies with which value the synthesis is performed, calculates the number of logic signal lines in a logic circuit as Log₂ a raised integer of (the specifying value), and logically connects the respective signal lines.

### BRIEF DESCRIPTION OF THE DRAWINGS

FIG. 1 is a block diagram illustrating the functional configuration of a logic emulation system for performing a multi-valued logic emulation in accordance with one embodiment of the present invention;

FIG. 2 is a block diagram illustrating the functional configuration of a multi-value supporting synthesis processing unit in the embodiment of the present invention;

FIG. 3 is a block diagram illustrating the functional configuration of a multi-value supporting logic compile processing unit in the embodiment of the present invention;

FIG. 4 is a diagram for explaining a plurality of exemplary logic cells stored in a synthesis library in the embodiment of the present invention;

FIG. 5 is a diagram for explaining the synthesis to a multi-value supporting logic in the embodiment of the present invention;

FIG. 6 is a table showing a correspondence of logic signals to physical signals in the embodiment of the present invention;

FIG. 7 is a diagram for explaining the configuration of a programmable gate array in the embodiment of the present invention;

FIG. 8 is a block diagram illustrating the configuration of a logic cell block in the gate array in the embodiment of the present invention;

FIG. 9 is a diagram for explaining the configuration of a programmable logic configuration unit in the embodiment of the present invention; and

FIG. 10 is a block diagram illustrating the configuration of a logic emulation system in one embodiment of the present invention.

### DESCRIPTION OF THE EMBODIMENTS

One embodiment of a logic emulation system according to the present invention will hereinafter be described in detail with reference to the accompanying drawings.

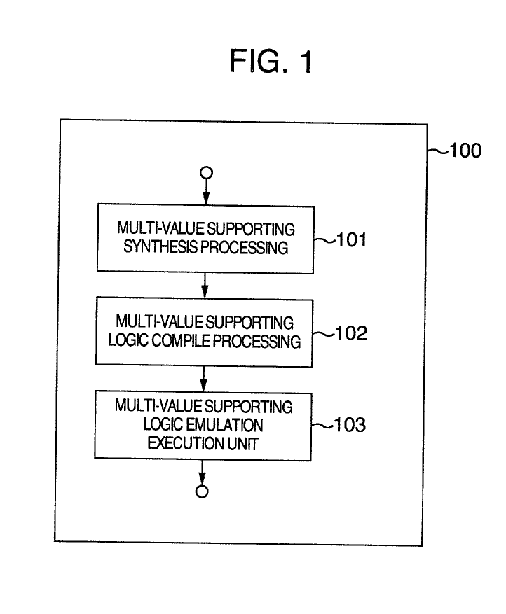

In FIGS. 1 to 10, reference numeral 100 designates a logic emulation system; 101, a multi-value supporting synthesis processing unit; 102, a multi-value supporting logic compile processing unit; 103, a multi-value supporting logic emulation execution unit; 201, preprocessing; 202, mapping processing; 203, signal line extension processing; 210, a value information holding unit; 211, a logic circuit information file; 212, a synthesis library; 301, place and route processing; 302, programming word generation processing; 311, a multi-value supporting logic circuit information file; 501, 502, library cells; 600, a table; 701, a logic cell block; 801, a programmable logic configuration unit; 802, a programmable route selection unit; 803, a programming word storage unit; and 904, a truth table.

FIG. 1 illustrates the logic emulation system 100 for performing multi-valued logic emulation in accordance with one embodiment of the present invention. The logic emulation system 100 comprises the multi-value supporting synthesis processing unit 101; the multi-value supporting logic compile processing unit 102; and a multi-value supporting logic emulation execution unit 103. Then, in this embodiment, these processing units 101, 102 and execution unit 103 perform the associated processing in order.

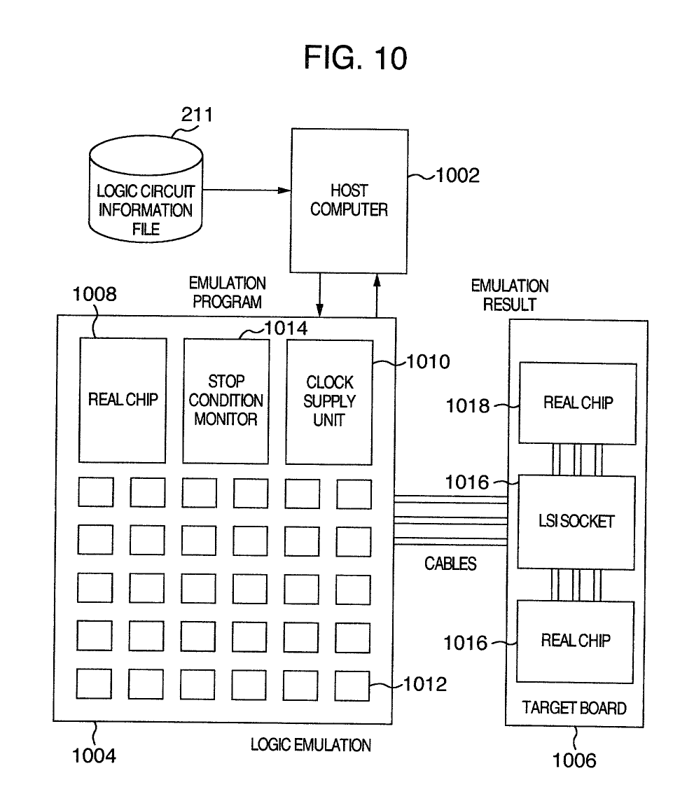

FIG. 10 illustrates a hardware configuration in one embodiment of the present invention. In FIG. 10, a host computer 1002 comprises a processor, a storage device, an input device, and so on. The host computer 1002 reads the logic circuit information file 211 for compilation to create an emulation program. Then, the host computer 1002 loads the emulation program into a logic emulator 1004 so that the logic emulation is available. The logic emulator 1004 comprises a plurality of module units 1012, each of which operates in synchronism with a clock from a clock supply unit 1010. A stop condition monitor 1014 monitors a stop condition for the logic emulation, and stops supplying the clock if the stop condition is established, and transfers the result of the emulation to the host computer 1002. The stop condition monitor 1014 operates under control of the host computer 1002 to perform substitution and reference of a signal value for the logic emulator 1004. The stop condition monitor 1014 can also display a waveform. The logic emulator 1004 can associate a real chip 1008 such as a CPU, a memory or the like with the logic circuit information file 211 to perform logic emulation. When the logic emulator 1004 is connected to an LSI socket 1016 on a target board through a cable, an in-circuit emulation can also be performed.

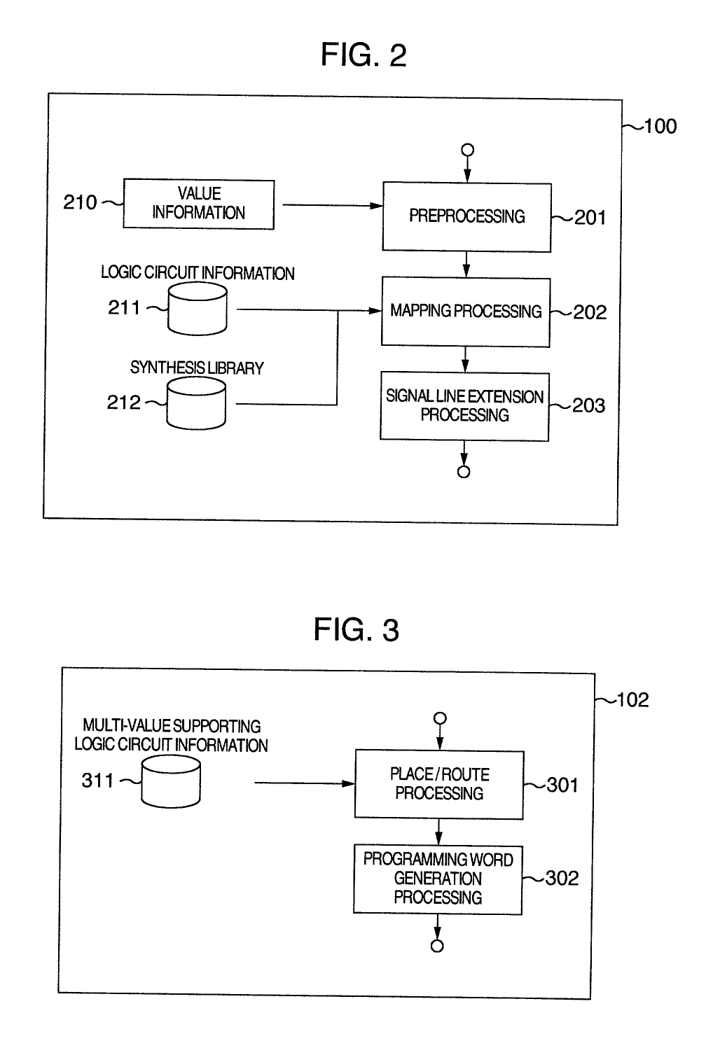

FIG. 2 illustrates the multi-value supporting synthesis processing unit 101 in the embodiment of the present invention. The multi-value supporting synthesis processing unit 101 is implemented by the host computer 1002 in FIG. 10, and performs a variety of processing such as the preprocessing 201, mapping processing 202, signal line extension processing 203 and so on.

Also, the multi-value supporting synthesis processing unit 101 comprises the value information holding unit 210, the logic circuit information file 211, and the synthesis library 212. These components are implemented, for example, by a storage device which may reside in the host computer 1002. The value information holding unit 210 holds value information for specifying which value of synthesis is to be performed. The value information may be previously inputted, for example, through the input device of the host computer 1002, or the multi-value supporting synthesis processing unit 101 may determine a required value. The value information specified in such a manner is held in the value information holding unit 210. The logic circuit information file 211 is a file for storing circuit information on a circuit under logic emulation. The synthesis library 212 in turn is a file for storing a multi-valued synthesis cell library for each of various operations.

The multi-value supporting synthesis processing unit 10 performs the preprocessing 201 in the following manner. First, the multi-value supporting synthesis processing unit 101 reads value information from the value information holding unit 210, and finds the number of physical signal lines required to implement one logic signal line of a multi-valued logic signal. The number n of physical signal lines can be calculated using a function shown in the following equation (1):

Number n of Physical Signal Lines=Log₂ Raised Integer of (Value Information) (1)

The concept underlying the above equation is that since a single physical signal line carries binary logic signals (logic level), for example, “0” and “1”, the number of physical signal lines equal to “Log₂ (a raised integer of x)” are required to represent an x-valued logic signal. Therefore, the number of physical signal lines required to implement one logic signal line, for example, during four-valued logic emulation is derived as Log₂ 4=2 from the equation (1). As appreciated from the above, two physical signal lines are required to implement one logic signal line.

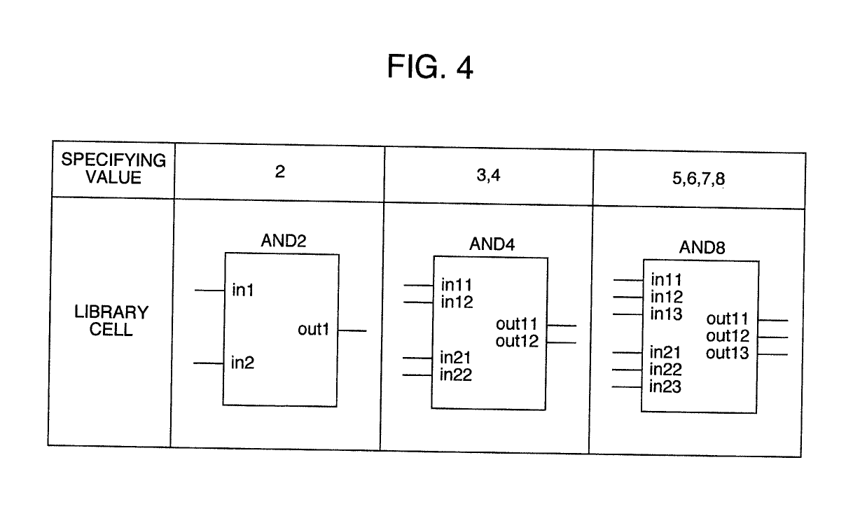

Details on the mapping processing 202 is described below. First, the multi-value supporting synthesis processing unit 10 reads the logic circuit information file 211, and performs multi-value supporting synthesis using the multi-valued synthesis library 212. FIG. 4 illustrates an example of the multi-valued synthesis library 212. The multi-valued synthesis library 212 stores information on a logic cell corresponding to a specifying value that specifies which value of logic signal is to be handled. FIG. 4 illustrates binary, four-valued, and eight-valued AND cells for performing AND operations, as examples of logic cells corresponding to some specifying values. Though not shown, this library 212 also stores a plurality of groups of logic cells having different numbers of pins, corresponding to a plurality of operations such as OR operation, NAND operation, NOR operation and so on, respectively, as logic cell groups for the respective operations.

Further, the mapping processing involves a selection of a library cell corresponding to a required logic operation from the multi-valued synthesis library 212. For example, for performing a four-valued AND logic operation, AND 4 is selected from four-value library cells. The multi-value supporting synthesis processing unit 101 also has a function of carrying out optimal mapping. For example, the multi-value supporting synthesis processing unit 101 selects a four-value cell library for three-valued synthesis, and an eight-value cell library for five-, six- and seven-valued synthesis, respectively.

The multi-valued synthesis library 212 further stores rules for selecting signals for all pin labels of a library cell for connection thereto. For example, the multi-valued synthesis library 212 stores a program for extending a signal before the synthesis to a signal name and an additional extension number. In this event, as illustrated in FIG. 4, connections of all signal lines are determined by the last numerals of the respective pin labels through the signal line extension processing, later described.

After completing the mapping processing for a multi-valued operation, the multi-value supporting synthesis processing unit 101 performs the signal line extension processing 203. The signal line extension processing 203 involves extension of the number of logic signal lines in accordance with the required number of physical signal lines calculated in the preprocessing 201. The number of signal lines duplicated for this purpose is derived, using the required number of physical signal lines calculated in the preprocessing 201, as expressed by (the required number of physical signal lines minus one) for one logic signal line. This means that since one physical signal line has been originally reserved, the reserved one line is subtracted from the required number of physical signal lines calculated in the preprocessing 201. Therefore, when the logic emulation is first performed for a four-valued logic operation and must be later changed for a five-valued logic operation, one (=3-2) line is duplicated because the required number of physical signal lines is three and the number of previously reserved physical signal lines are two. The required physical signal lines and extended logic signal lines are connected in accordance with extension rules.

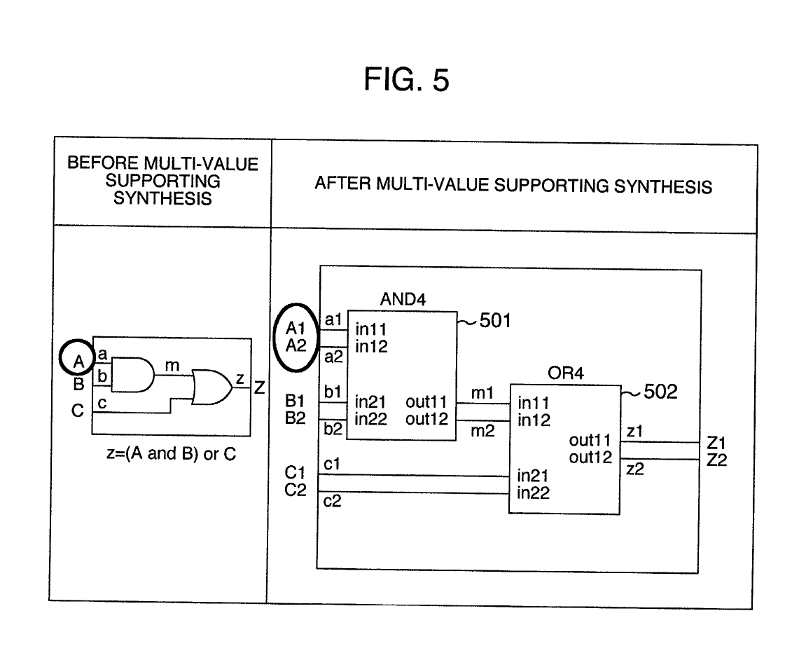

Next, a specific example of performing four-valued synthesis from an extended binary logic circuit will be explained with reference to FIG. 5. FIG. 5 illustrates an example in which a logic circuit before multi-value supporting synthesis, which has four-valued logic input ports A, B, C and a logic output port Z and is comprised of one AND circuit and one OR circuit, is synthesized by the signal line extension processing. Assume, in this example, that the extension rules define that “a signal before synthesis is extended by a signal name and an additional extension number”. Assume also that the rules for selecting signals for connection are similar to those mentioned above.

In the example illustrated in FIG. 5, the required number of physical signal lines is calculated to be two in the preprocessing 201 since value information stored in the value information holding unit 210 is four. In the next mapping processing 202, the port A before the multi-valued synthesis is synthesized in accordance with the extension rules, and extended to two ports, i.e., port A1 and port A2. The port B, port C, port Z are also extended to ports B1, B2, ports C1, C2, and ports Z1, Z2, respectively, in a similar manner. Also, in the signal line extension processing 203, each of internal signal lines a, b, c, z, m is extended likewise to two signal lines, respectively. A connection of each port to an internal signal line is also made in accordance with the aforementioned rules. For example, a signal line connected to the port Al is an internal signal line a1, and a signal line connected to the port A2 is an internal signal line a2. A connection of any other port signal to an internal signal line is also made in a similar manner. Further, since rules for selecting a signal for connection are assumed to be the same rules for the signal line extension, a connection of each pin to an internal signal line is made in a similar manner in multiple library cells included in the synthesis library 212.

As a result of the foregoing processing, the logic circuit before the multi-value supporting synthesis is transformed into a logic circuit after the multi-value supporting synthesis, as illustrated in the right column of FIG. 5, which is comprised of a four-valued AND library cell 501, and a four-valued OR library cell 502. For example, the library cell 501 has a pin in11 connected to an internal signal line a1 and a pin in12 to an internal signal line a2. A similar connection scheme is applied to the library cell 502. In this way, a net list available for execution of four-valued logic emulation is created.

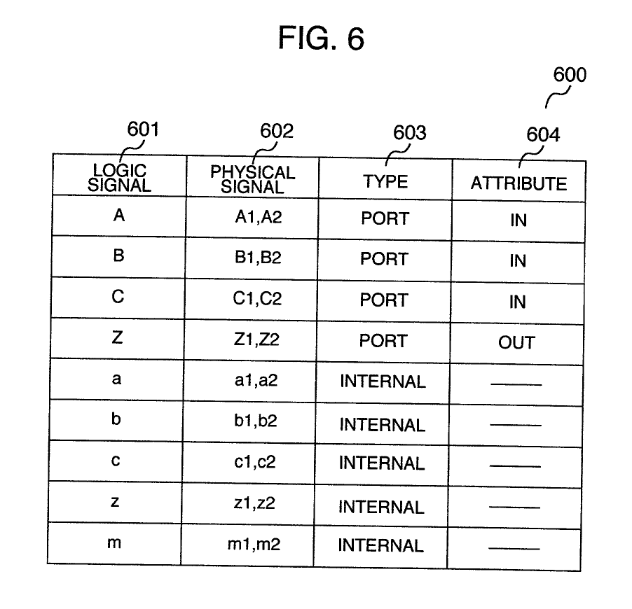

FIG. 6 shows a table which lists a correspondence relationship between signals involved in the synthesis processing as described above. Specifically, FIG. 6 shows in the form of table the correspondence of signals before the multi-valued synthesis (logic signals) created in the aforementioned multiplexing to signals after the logic synthesis (physical signals). In the following, the correspondence of the logic signals to the physical signals will be explained with reference to FIG. 6.

The table 600 shown in FIG. 6 is held by the multi-value supporting synthesis processing unit 101. The table 600 is comprised of the following columns: logic signal name 601 before multi-valued synthesis; physical signal name 602 after extension; type 603; and attribute 604. The logic signal name 601 indicates signal names in a circuit under emulation. The physical signal name 602 indicates names of signals created by the extension processing. The type 603 indicates information as to where the associated signal is allocated, while the attribute 604 indicates input/output information on the associated signal. Since the multi-valued logic emulation is performed using physical signals, physical signal names can be converted to logical signal names by referencing this correspondence table for signal observation or the like.

Next, the multi-value supporting logic compile processing unit 102 in FIG. 1 is explained with reference to FIG. 3. FIG. 3 illustrates the multi-value supporting logic compile processing unit 102 in the embodiment of the present invention. This processing unit 102 is also implemented by the host computer 1002.

The multi-value supporting logic compile processing unit 102 performs the place and route processing 301 and the programming word generation processing 302. For the processing 301, 302, the multi-value supporting logic compile processing unit 102 uses the multi-value supporting logic circuit information file 311 which is a file outputted from the signal line extension processing 203 of the multi-value supporting synthesis processing unit 101. In the place and route processing 301, the multi-value supporting logic compile processing unit 102 reads the multi-value supporting logic circuit information file 311, and determines connections within a programmable gate array based on the information in the file 311. In the programming word generation processing 302, in turn, the multi-value supporting logic compile processing unit 102 creates a multi-valued logic emulation program.

As described above, the multi-valued logic emulation program is realized by the foregoing processing performed by the multi-value supporting synthesis processing unit 101 and the multi-value supporting logic compile processing unit 102. The multi-valued logic emulation execution unit 103 in FIG. 1 executes the multi-valued logic emulation using the host computer 1002 by loading the multi-valued logic emulation program into the logic emulator 1004.

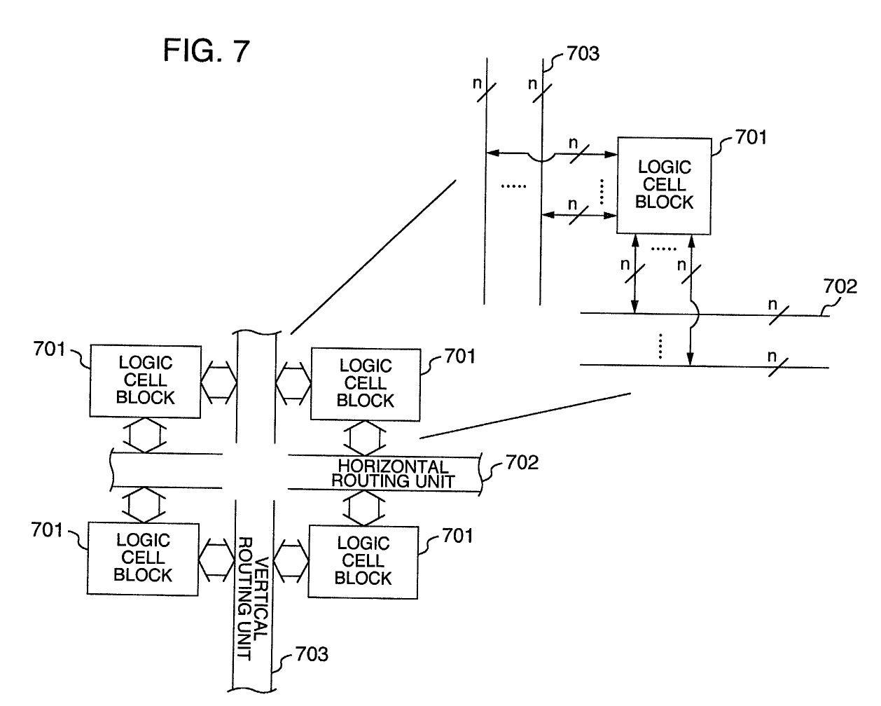

FIG. 7 illustrates the configuration of a programmable gate array for executing the multi-valued logic emulation in accordance with the embodiment of the present invention. The illustrated programmable gate array is realized by the module unit 1012 in the logic emulator 1004 of FIG. 10. As can be seen from the configuration illustrated in FIG. 7, the programmable gate array comprises multiple logic cell blocks 701, each of which includes a processor, arranged in an array form; a horizontal routing unit 702; and a vertical routing unit 703. The horizontal routing unit 702 is routed in the horizontal direction between the respective cell blocks 701, and is connected to the respective cell blocks 701. The vertical routing unit 703 in turn is routed in the vertical direction between the respective cell blocks 701, and connected to the respective cell blocks 701.

Each of the cell blocks 701 has n physical signal lines for one logic signal line. The number n of physical signal lines has been calculated in the signal extension processing 203 during the multi-valued synthesis, and a required number of physical signal lines are allocated from previously provided X (≧n) signal lines. The horizontal routing unit 702 and the vertical routing unit 703 also have n physical signal lines for one logic signal line as mentioned above. Connections of a logic cell block 701 to the horizontal routing unit 702 and the vertical routing unit 703 are made by connecting corresponding physical signal lines of the logic cell block 701 to those of the horizontal and vertical routing units 702, 703.

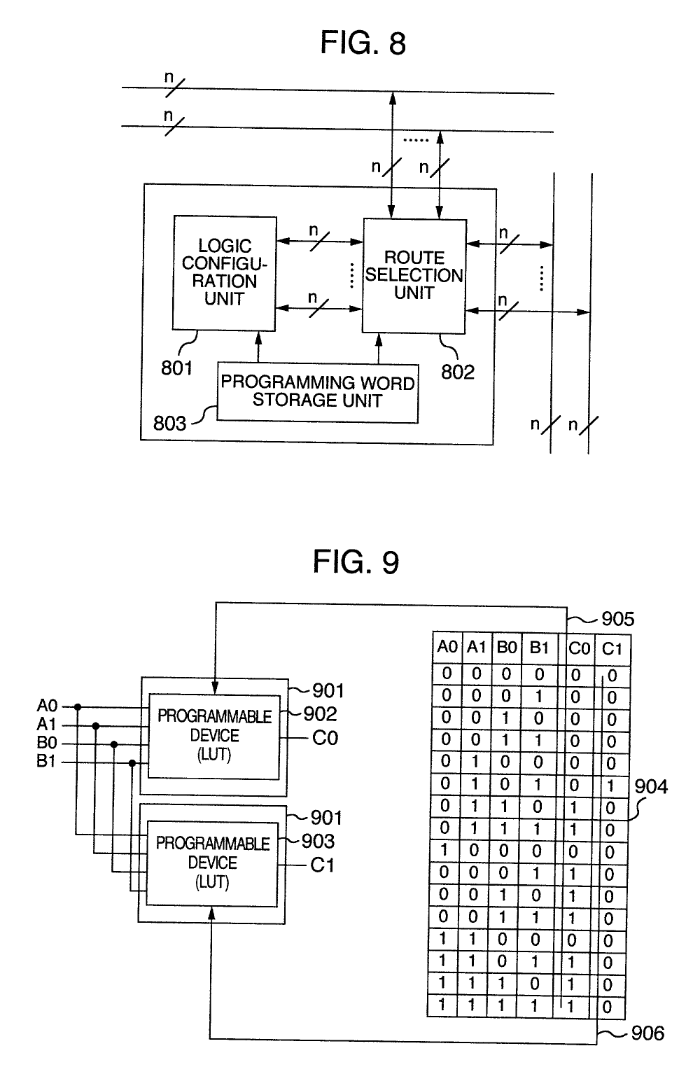

FIG. 8 illustrates the internal configuration of the logic cell block 701. The logic cell block 701 comprises the programmable logic configuration unit 801; the programmable route selection unit 802; and the programming word storage unit 803. The programming word storage unit 803 stores a programming word created by the multi-value supporting logic compile processing unit 102. The programmable logic configuration unit 801 is coupled to the programmable route selection unit 802 in accordance with a stored programming word to make appropriate connections between logic cell blocks.

FIG. 9 illustrates the internal configuration of the programmable logic configuration unit 801. The programmable logic configuration unit 801 generally comprises programmable devices (generally, a four-input/one-output lookup table (LUT)). The example of FIG. 9 shows that the programmable logic configuration unit 801 is made up of two programmable devices (LUT) 902, 903, and data in a truth table 904 is written into the programmable devices 902, 903. One or a plurality of programmable devices (LUT) may be used to allow for the execution of a variety of operations. writing of values into these two programmable devices (LUT) 902, 903 is basically performed by loading a truth table from the programming word storage unit 803. For example, in a four-valued AND operation, an output section 905 in the four-valued AND truth table 904 described in the programming word storage unit 803 is loaded into the programmable device (LUT) 902, while an output section 906 is loaded into the programmable device (LUT) 903. The actual operation is performed in accordance with addresses comprised of combinations of input values A0, A1, B0, B1 with reference to the programmable devices (LUT) 902, 903.

According to the foregoing embodiment of the present invention, a value is specified for performing the multi-valued logic emulation with this value, a corresponding number of physical signal lines is calculated from the specified value, and the synthesis processing is performed in accordance with the number of physical signal lines. By using the result of the synthesis processing, assignment of signal lines to a programmable gate array can be accomplished in consideration of the specified value. The embodiment of the present invention can facilitate multi-valued logic emulation of three or more values through the foregoing process steps.

While in the embodiment described above, all logic operations are uniformly performed in a multi-valued configuration, it is also possible to select portions of logic operations and specify different values to the respective portions. In this event, the synthesis may also be performed such that the selected logic operations are carried out with multi-values of different specified values. In this event, the value information stored in the value information holding unit 210 specifies the number of signals involved in a logic operation implemented by each portion corresponding to that portion. In this way, the present invention can perform the emulation of a logic circuit including a plurality of multi-valued logics by previously specifying arbitrarily with which value the logic emulation is performed, and representing each multi-valued logic with a plurality of physical signal lines corresponding to a required logic value.

1. A logic emulation system for emulating a logic under verification, comprising:
a synthesis unit for synthesizing a multi-value supporting logic for said logic under verification;
a logic compile unit for assigning said multi-value supporting logic to a programmable gate array; and
an emulation unit for performing multi-value supporting logic emulation using the programmable gate array to which said compile unit assigns said multi-value supporting logic.

2. A logic emulation system according to claim 1, wherein:
said synthesis unit implements one logic signal line for transmitting a multi-valued logic signal by a plurality of physical signal lines to synthesize the logic.

3. A logic emulation system according to claim 1, wherein:
said synthesis unit includes a value information storage unit for storing value information, and performs multi-valued synthesis corresponding to a value stored in said value information storage unit.

4. A logic emulation system according to claim 1, wherein:
said synthesis unit performs logic synthesis using information on a logic cell stored in a cell library for multi-value supporting synthesis.

5. A logic emulation system according to claim 1, wherein:
said synthesis unit reads a specifying value that specifies with which value the synthesis is performed, calculates the number of logic signal lines in a logic circuit as Log₂ a raised integer of (the specifying value), and logically connects the respective signal lines.

6. A logic emulation system according to claim 1, wherein:
said system performs one logic gate operation using a programmable device in said programmable gate array in a one-input/one-output configuration, a one-input/multiple-output configuration, a multiple-input/one-output configuration, or a multiple input/multiple output configuration to implement a multi-valued logic operation.

7. A multi-valued logic emulation system for emulating a logic under verification, said system having an information processing unit and a logic emulator including a plurality of rewritable logic devices constituting a logic circuit, wherein said information processing unit comprises:
a first storage unit for storing information on a logic circuit under emulation;
a second storage unit for storing value information on a logic value of said logic circuit; and
a processing unit for calculating a required number of physical signal lines from said logic circuit information and said value information, and mapping and compiling said logic circuit in accordance with said number of physical signal lines to create a multi-valued emulation program.

8. A multi-valued logic emulation system according to claim 7, wherein:
said information processing unit calculates a required number of physical signal lines using said value information by the following equation:
Number n of Physical Signal Lines=Log₂ Raised Integer of Value Information.

9. A multi-valued logic emulation system according to claim 7, wherein said information processing unit further comprises:
an input device for inputting said value information.

10. A multi-value supporting logic emulation method executed by an information processing unit and a logic emulator including a plurality of writable logic devices, said method comprising the steps of:
said information processing unit reading information on a logic circuit to be emulated;
said information processing unit storing value information on a logic value of said logic circuit in a storage unit;
said information processing unit calculating a required number of physical signal lines from said read logic circuit information and said value information; and
said information processing unit creating a multi-valued logic emulation program for said logic circuit in accordance with the number of physical signal lines.

11. A multi-value supporting logic emulation method according to claim 10, wherein:
said information processing unit calculates a required number of physical lines using said value information by the following equation:
Number n of Physical Signal Lines=Log₂ Raised Integer of Value Information.

12. A multi-value supporting logic emulation method according to claim 11, wherein:
said information processing unit acquires said value information using an input device.
